(19) United States
(12) Patent Application Publication
(10) Pub. No.: US 2026/0220967 A1
(43) Pub. Date: Jul. 30, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Ryo YAMAKABE, Tokyo (JP)

(73) Assignee: NEC Corporation, Tokyo (JP)

(21) Appl. No.: 19/147,374

(22) PCT Filed: Jan. 17, 2023
(86) PCT No.: PCT/JP2023/001156

§ 371 Date: Jul. 11, 2025

(51) Int. Cl. G06V 40/19; G06T 7/20; G06V 40/18; G06V 40/20; H04N 23/611

(52) U.S. Cl. CPC G06V 40/19; G06T 7/20; G06V 40/197; G06V 40/25; H04N 23/611; G06T 2207/30196

(57) ABSTRACT

An information processing apparatus including: an acquisition unit that acquires gait information indicating a gait of a target; an arrival estimation unit that estimates when the target will arrive at a focal plane of a camera based on the gait information; and a control unit that controls a capturing by the camera in accordance with the estimation result of the arrival estimation unit.

### TECHNICAL FIELD

This disclosure relates to the technical field of information processing apparatus, information processing methods, and recording media.

### BACKGROUND ART

Patent Literature 1 describes a technology for performing iris recognition when an iris image capable of iris recognition is

obtained by repeatedly capturing a face image while controlling the capture angle until an iris image capable of iris recognition can be captured after detecting a person by irradiating infrared light onto the person and detecting a person approaching the area outside the iris capture area of the imaging section.

Patent Literature 2 describes a method of receiving images taken continuously over time by an imaging apparatus in chronological order, extracting pedestrian candidate areas from the received images, selecting specific pedestrian areas, providing the selected pedestrian areas in chronological order, and estimating the movements of the pedestrian areas using a skeleton model modeled on pedestrians and distance conversion images obtained from the pedestrian area, and then linking the estimated pedestrian areas to the chronological order to track the pedestrian area being tracked a skeleton model of the pedestrian and distance-converted images obtained from the pedestrian area, and a Monte Carlo filter, and by associating them with the time direction, the pedestrian area is tracked, and the tracked pedestrian area is displayed in a time series.

Patent Literature 3 describes a technology for receiving gait data including pedestrian walking characteristics, extracting the features based on pedestrian walking characteristics from the gait data, using the gait data as sample data, learning the correlation between the extracted the features and pedestrian weight information to generate a learning model, and inputting the gait data to be estimated into the learning model to estimate the weight information corresponding to the gait data to be estimated.

Patent Literature 4 describes a technology for acquiring multiple images of a subject taken at different times, estimating the movement of the subject based on the multiple images, imaging a specific part of the subject according to the movement of the subject, changing the setting value of the imaging part, and imaging the subject.

### CITATION LIST

### Patent Literature

Patent Literature 1: JP2020-194599A
Patent Literature 2: WO2008/007471A
Patent Literature 3: WO2020/079782A
Patent Literature 4: WO2021/229761A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: an acquisition unit that acquires gait information indicating a gait of a target; an arrival estimation unit that estimates when the target will arrive at a focal plane of a camera based on the gait information; and a control unit that controls a capturing by the camera in accordance with the estimation result of the arrival estimation unit.

An information processing method according to an example aspect includes: acquiring gait information indicating a gait of a target; estimating when the target will arrive at a focal plane of a camera based on the gait information; and controlling a capturing by the camera in accordance with the estimation result.

A recording medium according to an example aspect is a recording medium on which a computer program that allows a computer to execute an information processing method is recorded, the information processing method including: acquiring gait information indicating a gait of a target; estimating when the target will arrive at a focal plane of a camera based on the gait information; and controlling a capturing by the camera in accordance with the estimation result.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a conceptual diagram showing gait.

FIG. 4 is a diagram showing an example of a situation in which an information processing apparatus according to this disclosure is applied.

FIG. 5 is a flowchart illustrating a flow of an information processing operation of the information processing apparatus according to this disclosure.

FIG. 6 is a block diagram illustrating a configuration of an information processing apparatus according to this disclosure.

FIG. 7 is a block diagram illustrating a configuration of an information processing apparatus according to this disclosure.

FIG. 8 is a block diagram illustrating a configuration of an information processing apparatus according to this disclosure.

FIG. 9 is a block diagram illustrating a configuration of an information processing apparatus according to this disclosure.

FIG. 10 is a flowchart illustrating a flow of an information processing operation of the information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### [1-1: Configuration of the Information Processing Apparatus 1]

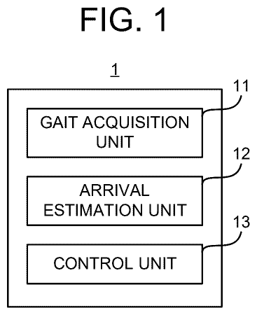

FIG. 1 is a block diagram showing the configuration of the information processing apparatus 1 according to the first embodiment. As shown in FIG. 1, the information processing apparatus 1 includes a gait acquisition unit 11, an arrival estimation unit 12, and a control unit 13.

The gait acquisition unit 11 acquires gait information indicating a gait of a target. The arrival estimation unit 12 estimates in case the target will arrive at a focal plane of a camera based on the gait information. The control unit 13 controls a capturing by the camera based on the estimation result from the arrival estimation unit 12.

### [1-2: Technical Effects of the Information Processing Apparatus 1]

The information processing apparatus 1 according to the first embodiment can estimate in case the target arrives at the focal plane of the camera and can capture the target that has arrived at the focal plane of the camera.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### [2-1: Configuration of the Information Processing Apparatus 2]

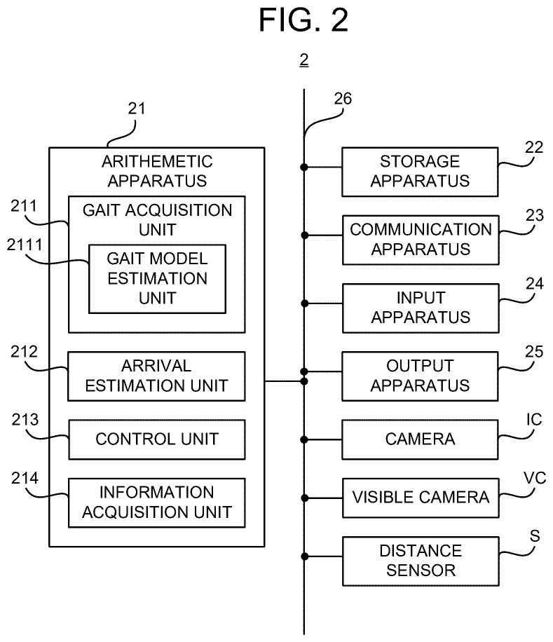

FIG. 2 is a block diagram showing the configuration of the information processing apparatus 2 according to the second embodiment. As shown in FIG. 2, the information processing apparatus 2 is provided with an arithmetic apparatus 21 and a storage apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26. The information processing apparatus 2 may include a camera IC, a visible camera VC, and a distance sensor S. Alternatively, the information processing apparatus 2 may transmit and receive information with the camera IC, the visible camera VC, and the distance sensor S via the communication apparatus 23.

The arithmetic apparatus 21 may be, for example, a CPU (Central Processing Unit), a GPU (Graphics Processing Unit), and/or an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-temporary recording medium using a recording medium reading device (e.g., the input apparatus 24 described later) provided in the information processing apparatus 2. The arithmetic apparatus 21 may obtain (i.e., download or read) a computer program from an apparatus not shown, which is disposed outside the information processing apparatus 2, via the communication apparatus 23 (or other communication apparatus). The arithmetic apparatus 21 executes the read computer program. As a result, logical functional blocks for executing the operations to be performed by the information processing apparatus 2 are realized within the arithmetic apparatus 21. In other words, the arithmetic apparatus 21 functions as a controller for realizing logical functional blocks for executing the operations (i.e., processing) to be performed by the information processing apparatus 2.

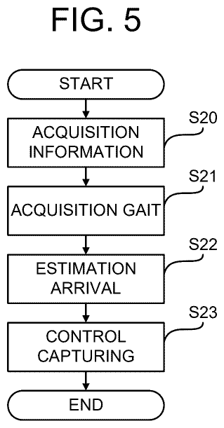

FIG. 2 shows an example of logical function blocks realized within the arithmetic apparatus 21 for executing information processing operations. As shown in FIG. 2, the arithmetic apparatus 21 includes a gait acquisition unit 211, which is a specific example of the “acquisition unit” described in the Supplementary Note described later, an arrival estimation unit 212, which is a specific example of the “arrival estimation unit” described in the Supplementary Note described later, a control unit 213, which is a specific example of the “control unit” described in the Supplementary Note described later, and an information acquisition unit 214. However, the information acquisition unit 214 may not be realized within the arithmetic apparatus 21. The gait acquisition unit 211 may include a gait model estimation unit 2111, which is a specific example of the “gait model estimation unit” described in the supplementary note described below. The details of the operations of the gait acquisition unit 211, the arrival estimation unit 212, the control unit 213, and the information acquisition unit 214 will be explained later with reference to FIG. 5.

The storage apparatus 22 is capable of storing desired data. For example, the storage apparatus 22 may temporarily store the computer program executed by the arithmetic apparatus 21. The storage apparatus 22 may temporarily store data temporarily used by the arithmetic apparatus 21 in case the arithmetic apparatus 21 is executing the computer program. The storage apparatus 22 may store data that the information processing apparatus 2 stores long-term. Note that the storage apparatus 22 may include at least one of RAM (Random Access Memory), ROM (Read Only Memory), a hard disk apparatus, an optical magnetic disk apparatus, an SSD (Solid State Drive), and a disk array apparatus. In other words, the storage apparatus 22 may include a non-temporary recording medium.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading device capable of reading information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display device (a so-called display) capable of displaying images indicating the information to be output. For example, the output apparatus 25 may output information as sound. In other words, the output apparatus 25 may include a sound device (a so-called speaker) capable of outputting sound. For example, the output apparatus 25 may output information on paper. In other words, the output apparatus 25 may include a printing device (so-called printer) capable of printing desired information on paper.

### [2-2: Gait]

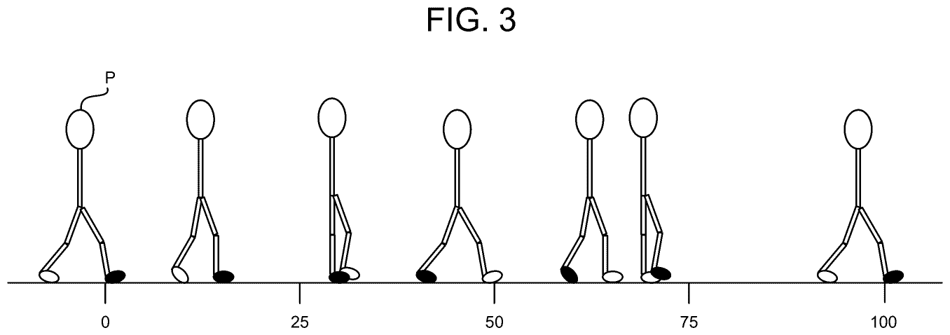

In this embodiment, the target is a walker P. FIG. 3 is a conceptual diagram of gait. As shown in FIG. 3, a posture of the walker P changes in a walking motion. In this embodiment, a posture of the walker P during the walking motion is referred to as “gait.” Gait changes periodically. FIG. 3 illustrates one cycle of gait. The posture of the walker P shown in ‘0’ in FIG. 3 and the posture of the walker P shown in “100” in FIG. 3 are substantially similar. In the case shown in FIG. 3, one cycle of gait may refer to the interval from in case one foot lands (the case of “0” shown in FIG. 3) to in case the same foot lands again (the case of “100” shown in FIG. 3).

In the walking motion, a center of gravity of the walker P is displaced in a back and forth direction. It is known that until the middle of the double support phase, a forward acceleration is generated at the center of gravity, and from the middle of the double support phase, a backward acceleration is generated at the center of gravity, causing braking. In other words, the walking speed of the walker P is not constant, but accelerates or decelerates. That is, the moving speed varies depending on the gait, and the amount of movement in the back and forth direction varies depending on the gait.

In addition, in the walking motion, the center of gravity of the walker P is displaced in an up and down direction. In FIG. 3, for example, in case of focusing on the head of the walker P, it can be understood that the head of the walker P is displaced in the up and down direction. In addition, in case of focusing on the eyes of the walker P, it is known that the height of the eyes is lowest in case both feet are on the ground, and the height of the eyes is highest in case the feet are off the ground.

It is relatively easy to acquire the displacement in the up and down direction. It is easier to capture the periodic transition of gait in the up and down direction than to capture the periodic transition of gait in the back and forth direction.

[2-3: Example of a Scene where the Information Processing Apparatus 2 is Applied]

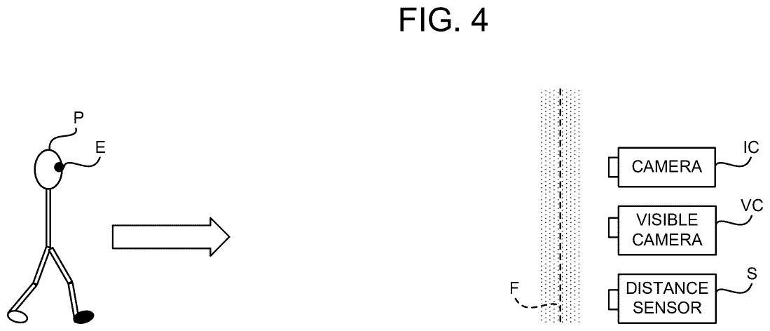

FIG. 4 shows an example of a scene where the information processing apparatus 2 is applied. As shown in FIG. 4, the camera IC captures the walker P walking toward the camera IC. The camera IC is controlled to capture the walker P at the focal plane F. The visible camera VC captures an image of the walker P walking toward the camera IC. The visible camera VC captures an image capable of detecting the specific part E of the walker P. Note that in this embodiment, the camera IC and the visible camera VC are described as separate configurations, but they may have the same configuration. The distance sensor S detects the distance from the focal plane F of the camera IC to the walker P.

### [2-4: Information Processing Operations Performed by the Information Processing Apparatus 2]

Referring to FIG. 5, the flow of information processing operations performed by the information processing apparatus 2 will be described. FIG. 5 is a flowchart showing the information processing operations performed by the information processing apparatus 2.

As shown in FIG. 5, the information acquisition unit 214 acquires displacement information indicating the displacement of the specific part E of the walker P in three-dimensional space and distance information indicating the distance between the focal plane F and the specific part E of the walker P (step S20). The information acquisition unit 214 may acquire images captured by the visible camera VC and acquire the displacement information. The information acquisition unit 214 may acquire the distance information indicating the distance detected by the distance sensor S from the distance sensor S. Alternatively, the information acquisition unit 214 may acquire the distance information from the image captured by the visible camera VC. The information acquisition unit 214 may, for example, use the distance between the two eyes of the walker P as seen in the image captured by the visible camera VC to calculate the distance between the walker P and the focal plane F, and acquire the distance information.

The gait acquisition unit 211 acquires the gait information indicating the gait of the walker P (step S21). The gait information may be information indicating the walking characteristics of the walker. The gait information may include a gait model of the walker P.

### [Gait Model]

In this embodiment, a model that imitates the gait is referred to as the “gait model.” The gait model may be a model that imitates the periodicity of the gait. For example, the gait model may be a model that imitates the periodicity of changes in the specific part E of the walker P. For example, the gait model may be a model that imitates the periodicity of changes in the height of the specific part E of the walker P.

The specific part E of the walker P may be any position of the body of the walker P. The specific part E of the walker P may be a feature point of the walker P. Examples of the feature point of the walker P include the eyes, nose, and face of the walker P. For example, in case the camera IC acquires eye images for iris recognition, the eyes may be adopted as the feature point of the walker P. In this case, the gait model may be a model that imitates the periodicity of changes in the height of the eyes of the walker P.

In case the eyes are adopted as the specific part E imitated by the gait model, the gait model can be used as information in case of capturing images for iris recognition. The specific part E of the walker P may be any part of the body of the walker P, such as the heel, but in case the image capture target of the camera IC is the eyes, adopting a location near the eyes as the specific part E allows it to be used for determining the position of the image capture target, making it preferable.

In this embodiment, the visible camera VC and the distance sensor S are used together, and the movement of the eyes in three-dimensional space can be acquired from images continuously captured by the visible camera VC. For example, even in case the displaced amount is the same, the displacement of an object located relatively far away from the image is smaller than the displacement of an object located relatively close to the image. Therefore, the gait acquisition unit 211 may correct the displacement in the up and down direction using the distance information.

The gait model estimation unit 2111 estimates the gait model. The gait model estimation unit 2111 may analyze the displacement of the specific part E of the walker P in a plane perpendicular to a moving direction of the walker P based on the displacement information and the distance information acquired by the information acquisition unit 214. The gait model estimation unit 2111 may estimate the gait model that imitates a periodic displacement of the specific part E of the walker P in a plane perpendicular to the moving direction of the walker P.

The gait model estimation unit 2111 may analyze the displacement of the height of the specific part E of the walker P. The gait model estimation unit 2111 may estimate the gait model that imitates the periodic displacement of the height of the specific part E of the walker P. In addition, the gait acquisition unit 211 estimates an average walking speed associated with a gait cycle.

The arrival estimation unit 212 estimates when the walker P arrives at the focal plane F of the camera IC based on the gait information (step S22). As described above, even in case the distance is the same, the time required to arrive varies depending on the gait of the walker P. In particular, the time required to arrive at the focal plane F varies depending on the gait of the walker P. In this embodiment, an arrival time is accurately estimated using the gait information including the gait model.

The control unit 213 controls the capturing by the camera IC according to the estimation result by the arrival estimation unit 212 (step S23).

### [2-5: Technical Effects of the Information Processing Apparatus 2]

In case a moving speed of a moving object is constant, in case an accurate distance to a target position and the moving speed are acquired, it is possible to accurately know when the object will arrive at the target position. On the other hand, in case the moving speed of the moving object is not constant, even in case the accurate distance to the target position and an average speed of the moving speed are acquired, it is not possible to accurately know when the object will arrive at the target position. For example, in case the moving speed and the average speed are equal in the case of constant speed, the arrival timing at the target position in the case of non-constant speed may be later or earlier than the arrival timing in the case of constant speed.

As mentioned above, the moving speed of the walker P is not constant, and the moving speed changes during the gait cycle. Therefore, the walker P may arrive at the target position at a different timing than the object moving at the same speed as the average moving speed of the walker P.

For example, suppose that the horizontal axis represents distance in FIG. 3. In this case, the distance from point “0” to point “25,” the distance from point “25” to point “50,” the distance from point “50” to point “75,” and the distance from point ‘75’ to point “100” are all equal. On the other hand, the time required to arrive at the point “25” from the point “0,” the time required to arrive at the point “50” from the point “25,” the time required to arrive at the point “75” from the point “50,” and the time required to arrive at the point ‘100’ from the point “75” may not be equal. Alternatively, suppose that the horizontal axis in FIG. 3 represents time. In this case, the time from the “0” timing to the “25” timing, the time from the “25” timing to the “50” timing, the time from the “50” timing to the “75” timing, and the time from the ‘75’ timing to the “100” timing are equal. On the other hand, the distance traveled from the “0” timing to the “25” timing, the distance traveled from the “25” timing to the “50” timing, the distance traveled from the “50” timing to the “75” timing, and the distance traveled from the ‘75’ timing to the “100” timing may not be equal.

In case the exact timing of when the walker P arrives at the focal plane F of the camera IC is known, the capturing can be performed at that arrival timing. On the other hand, in case the estimated arrival time of the walker P at the focal plane F of the camera IC has a large error, it is necessary to capture many images before and after the estimated arrival time in order to capture the walker P at the focal plane F. Furthermore, it is necessary to select images in focus from the many captured images. Reducing the estimation error of when the walker P arrives at the focal plane F of the camera IC leads to a reduction in the number of images captured and also reduces the processing load for selecting images in focus.

The information processing apparatus 2 according to the second embodiment estimates the gait model that imitates the periodic displacement of the specific part E of the walker P related to the gait of the walker P, and accurately estimates when the walker P arrives at the focal plane F of the camera IC, thereby reducing the number of images captured by the camera IC. In addition, the information processing apparatus 2 can reduce the processing load for selecting images in focus.

### 3: Third Example Embodiment

Next, the third embodiment of the information processing apparatus, information processing method, and recording medium will be described. In the following, the third embodiment of the information processing apparatus, information processing method, and recording medium will be described using an information processing apparatus 3 to which the third embodiment of the information processing apparatus, information processing method, and recording medium is applied.

### [3-1: Configuration of the Information Processing Apparatus 3]

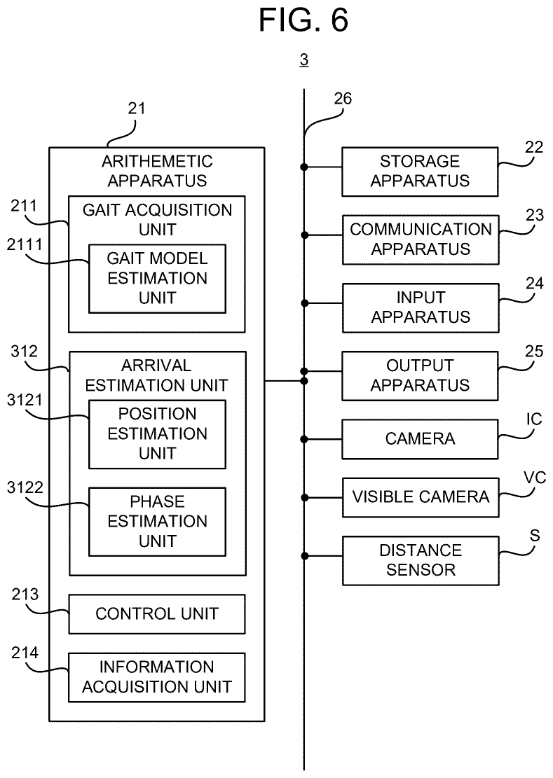

As shown in FIG. 6, the information processing apparatus 3 according to the third embodiment is similar to the information processing apparatus 2 according to the second embodiment, comprising the arithmetic apparatus 21 and the storage apparatus 22. Furthermore, the information processing apparatus 3 according to the third embodiment may also include the communication apparatus 23, the input apparatus 24, and the output apparatus 25, similar to the information processing apparatus 2 according to the second embodiment. However, the information processing apparatus 3 may not include at least one of the communication apparatus 23, the input apparatus 24, and the output apparatus 25. The information processing apparatus 3 according to the third embodiment differs from the information processing apparatus 2 according to the second embodiment in that it includes an arrival estimation unit 312 that includes a position estimation unit 3121 and a phase estimation unit 3122. The other features of the information processing apparatus 3 may be the same as those of the information processing apparatus 2 according to the second embodiment. Therefore, in the following, only the parts that differ from the previously described embodiments will be described in detail, and the other redundant parts will be omitted as appropriate.

### [3-2: Information Processing Operations Performed by the Information Processing Apparatus 3]

The position estimation unit 3121 estimates the position of the specific part E of the walker P at the time when the walker P arrives at the focal plane F of the camera IC, based on the gait model estimated by the gait model estimation unit 2111, the displacement information acquired by the information acquisition unit 214, and the distance information to estimate the position of the specific part E of the walker P when the walker P arrives at the focal plane F of the camera IC. The position estimation unit 3121 may also estimate the height of the specific part E of the walker P.

The phase estimation unit 3122 estimates the phase of the cycle of the gait model estimated by the gait model estimation unit 2111 and the position of the specific part E of the walker P when the walker P arrives at the focal plane F of the camera IC, the arrival estimation unit 312 estimates the phase corresponding to the cycle of the gait model when the walker P arrives at the focal plane F of the camera IC.

The arrival estimation unit 312 estimates when the walker P arrives at the focal plane F of the camera IC using the phase estimated by the position estimation unit 3121. For example, the arrival estimation unit 312 may estimate the time from the beginning of the cycle of the gait model (e.g., “0” shown in FIG. 3) to the phase estimated by the phase estimation unit 3122, and estimate when the walker P arrives at the focal plane F of the camera IC.

### [3-3: Technical Effects of the Information Processing Apparatus 3]

The information processing apparatus 3 according to the third embodiment estimates the phase corresponding to the cycle of the gait model, so it can accurately estimate when the walker P arrives at the focal plane F of the camera IC. The information processing apparatus 3 can reduce the estimation error of when the walker P arrives at the focal plane F of the camera IC, thereby reducing the number of images captured by the camera IC. Additionally, the information processing apparatus 2 can reduce the processing load for selecting in-focus images.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an information processing apparatus 4 to which the fourth embodiment of the information processing apparatus, information processing method, and recording medium is applied.

### [4-1: Configuration of the Information Processing Apparatus 4]

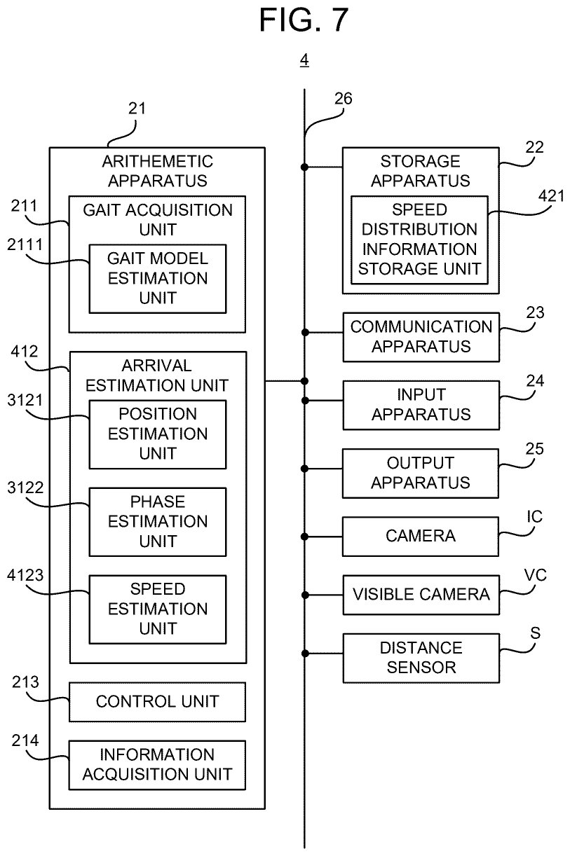

As shown in FIG. 7, the information processing apparatus 4 according to the fourth embodiment is similar to the information processing apparatus 2 according to the second embodiment and the information processing apparatus 3 according to the third embodiment, and includes the arithmetic apparatus 21 and the storage apparatus 22. Furthermore, the information processing apparatus 4 according to the fourth embodiment may also include the communication apparatus 23, the input apparatus 24, and the output apparatus 25, similar to the information processing apparatus 2 according to the second embodiment and the information processing apparatus 3 according to the third embodiment. However, the information processing apparatus 4 may not include at least one of the communication apparatus 23, the input apparatus 24, and the output apparatus 25. The information processing apparatus 4 according to the fourth embodiment differs from the information processing apparatus 2 according to the second embodiment and the information processing apparatus 3 according to the third embodiment in that it includes an arrival estimation unit 412 including a speed estimation unit 4123, and a speed distribution information storage unit 421 is provided within the storage apparatus 22. The speed distribution information storage unit 421 stores speed distribution information indicating the correspondence between the phase of gait and the distribution of the moving speed. The phase of gait and the distribution of the moving speed may be pre-learned information. The speed distribution information storage unit 421 may also store speed distribution information indicating the correspondence between the phase of gait and the changes in the moving speed corresponding to normal walking. The other features of the information processing apparatus 4 may be the same as the other features of the information processing apparatus 2 according to the second embodiment or the information processing apparatus 3 according to the third embodiment. Therefore, in the following, only the parts that differ from the already described embodiments will be explained in detail, and the other redundant parts will be omitted as appropriate.

### [4-2: Information Processing Operations Performed by the Information Processing Apparatus 4]

In normal walking, changes in the moving speed are correlated with the phase of the gait. Therefore, in the fourth embodiment, the estimated time of arrival of the walker P at the focal plane F of the camera IC is estimated using the correlation between the phase of the gait and the changes in the moving speed.

The speed estimation unit 4123 uses the speed distribution information registered in the speed distribution information storage unit 421 to estimate the moving speed corresponding to the phase of the gait model when the walker P arrives at the focal plane F of the camera IC estimated by the phase estimation unit 3122. The speed estimation unit 4123 may estimate the moving speed corresponding to each phase of the cycle of the gait model using the speed distribution information registered in the speed distribution information storage unit 421. The arrival estimation unit 412 estimates when the walker P will arrive at the focal plane F of the camera IC using the moving speed estimated by the speed estimation unit 4123.

The speed distribution information may include a correspondence relationship between each phase of the gait cycle and the moving speed. The speed distribution information may also include a correspondence relationship between each phase of the gait cycle and the acceleration of the moving speed. The speed distribution information may also include a correspondence relationship between each phase of the gait cycle and the displaced amount.

### [4-3: Technical Effects of the Information Processing Apparatus 4]

The information processing apparatus 4 according to the fourth embodiment uses the speed distribution with respect to the gait phase, so it can accurately estimate when the walker P will arrive at the focal plane F of the camera IC.

### 5: Fifth Example Embodiment

Next, the fifth embodiment of the information processing apparatus, information processing method, and recording medium will be described. In the following, the fifth embodiment of the information processing apparatus, information processing method, and recording medium will be described using an information processing apparatus 5 to which the fifth embodiment of the information processing apparatus, information processing method, and recording medium is applied.

### [5-1: Configuration of the Information Processing Apparatus 5]

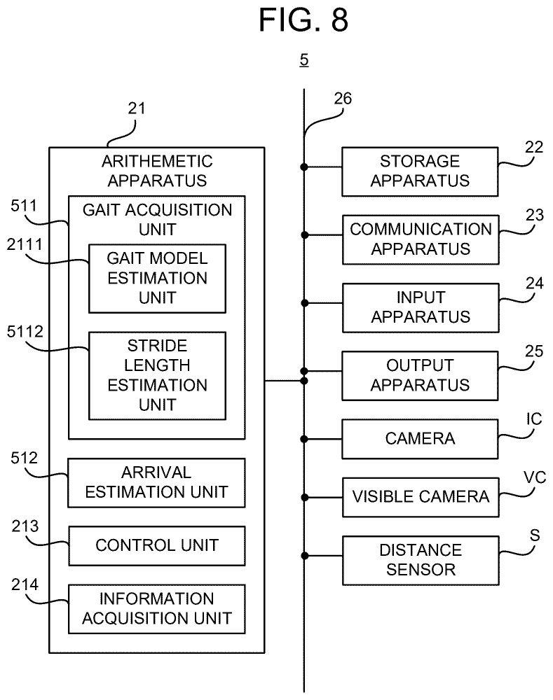

As shown in FIG. 8, the information processing apparatus 5 according to the fifth embodiment includes the arithmetic apparatus 21 and the storage apparatus 22, similar to the information processing apparatus 2 according to the second embodiment through the information processing apparatus 4 according to the fourth embodiment. Furthermore, the information processing apparatus 5 according to the fifth embodiment may include the communication apparatus 23, the input apparatus 24, and the output apparatus 25, similar to the information processing apparatus 2 according to the second embodiment through the information processing apparatus 4 according to the fourth embodiment. However, the information processing apparatus 5 may not include at least one of the communication apparatus 23, the input apparatus 24, and the output apparatus 25. The information processing apparatus 5 according to the fifth embodiment differs from the information processing apparatus 2 according to the second embodiment through the information processing apparatus 4 according to the fourth embodiment in that it further includes a gait acquisition unit 511 that includes a stride length estimation unit 5112. The other features of the information processing apparatus 5 may be the same as at least one of the other features of the information processing apparatus 2 according to the second embodiment through the information processing apparatus 4 according to the fourth embodiment. Therefore, in the following, only the parts that differ from the previously described embodiments will be described in detail, and the other redundant parts will be omitted as appropriate.

### [5-2: Information Processing Operations Performed by the Information Processing Apparatus 5]

A stride length may refer to the distance traveled per step. For example, suppose that the horizontal axis in FIG. 3 represents distance. In this case, the distance from the “0” point to the “50” point corresponds to the stride length. Alternatively, in this embodiment, the stride length may refer to the distance traveled per cycle of gait. In this case, the distance from the “0” point to the “100” point corresponds to the stride length.

The stride length estimation unit 5112 estimates the stride length of the walker P based on the displacement information and the distance information acquired by the information acquisition unit 214. An arrival estimation unit 512 further uses the stride length of the walker P to estimate when the walker P will arrive at the focal plane F of the camera IC.

### [5-3: Technical Effects of the Information Processing Apparatus 5]

The information processing apparatus 5 according to the fifth embodiment estimates the stride length of the walker P and further uses the stride length of the walker P, thereby enabling more accurate estimation of when the walker P arrives at the focal plane F of the camera IC.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### [6-1: Configuration of the Information Processing Apparatus 6]

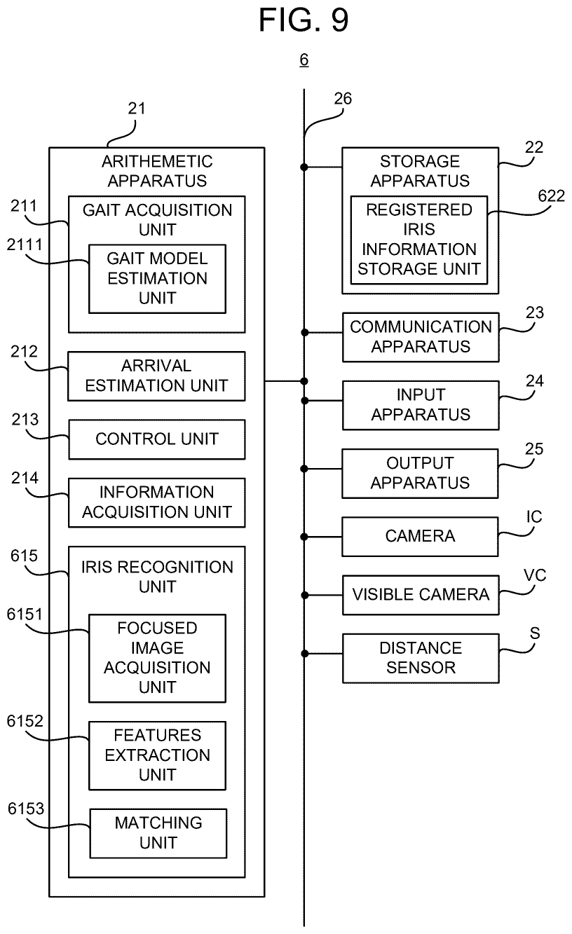

As shown in FIG. 9, the information processing apparatus 6 according to the sixth embodiment includes the arithmetic apparatus 21 and the storage apparatus 22, similar to the information processing apparatus 2 according to the second embodiment through the information processing apparatus 5 according to the fifth embodiment. Furthermore, the information processing apparatus 6 according to the sixth embodiment may include the communication apparatus 23, the input apparatus 24, and the output apparatus 25, similar to the information processing apparatus 2 according to the second embodiment through the information processing apparatus 5 according to the fifth embodiment. However, the information processing apparatus 6 may not necessarily include at least one of the communication apparatus 23, the input apparatus 24, and the output apparatus 25. The information processing apparatus 6 according to the sixth embodiment differs from the information processing apparatus 2 according to the second embodiment through the information processing apparatus 5 according to the fifth embodiment in that an iris recognition unit 615 is further realized within the arithmetic apparatus 21, and a registered iris information storage unit 622 is realized within the storage apparatus 22. The iris recognition unit 615 may include a focused image acquisition unit 6151, a features extraction unit 6152, and a matching unit 6153. The other features of the information processing apparatus 6 may be the same as at least one other feature of the information processing apparatus 5 according to the fifth embodiment. Therefore, in the following, in detail the parts that differ from the previously described embodiments will be described, and omit the description of other redundant parts as appropriate.

### [6-2: Information Processing Operations Performed by the Information Processing Apparatus 6]

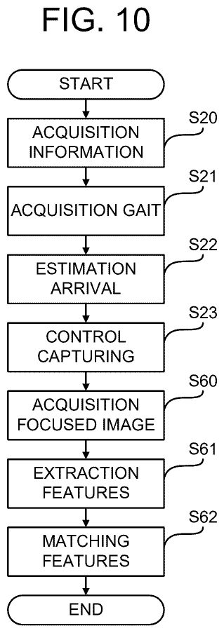

Referring to FIG. 10, the flow of information processing operations performed by the information processing apparatus 6 will be described. FIG. 10 is a flowchart showing the information processing operations performed by the information processing apparatus 6.

As shown in FIG. 10, the information acquisition unit 214 acquires the displacement information indicating the displacement of the specific part E of the walker P in the three-dimensional space and the distance information indicating the distance between the focal plane F and the specific part E of the walker P (step S20). The gait acquisition unit 211 acquires the gait information indicating the gait of the walker P (step S21). The arrival estimation unit 212 estimates when the walker P will arrive at the focal plane F of the camera IC based on the gait information (step S22). The control unit 213 controls the capturing by the camera IC in accordance with the estimation result from the arrival estimation unit 212 (step S23).

In the sixth embodiment, the camera IC captures the iris. That is, the control unit 213 controls the capturing of iris images including the iris of the walker P by the camera IC. In the sixth embodiment, the camera IC may be an infrared camera. In the sixth embodiment, the estimation result may include the timing of arrival having a time width, i.e., the timing of the capturing having a time width. The control unit 213 may cause the camera IC to capture multiple iris images including the iris of the walker P at the timing of the capturing having a time width.

The focused image acquisition unit 6151 acquires a focused image from multiple iris images including the iris of the walker P (step S60). The focused image acquisition unit 6151 may select one focused image from multiple iris images containing the iris of the walker P. The features extraction unit 6152 extracts the features from the focused image acquired by the focused image acquisition unit 6151 (step S61). The matching unit 6153 matches the features extracted by the features extraction unit 6152 with the registered iris information registered in the registered iris information storage unit 622 (step S62). The registered iris information registered in the registered iris information storage unit 622 may be the features extracted from the iris image by the features extraction unit 6152. The iris recognition unit 615 determines whether to recognize based on the matching result from the matching unit 6153. In other words, the iris recognition unit 615 performs iris recognition by matching the iris image captured under the control of the control unit 213 with the registered iris image that has been registered in advance.

### [6-3: Technical Effects of the Information Processing Apparatus 6]

For example, in case of the capturing the iris of the walker P from a distance, such as in walk-through iris recognition, the timing of the capturing is adjusted, the field of view of the camera is adjusted, etc., based on the depth of field of the camera, the required resolution conditions, etc., and the iris image near the focal plane F is often captured at a high frame rate. In addition, iris images suitable for recognition are extracted from the large number of iris images captured, and then iris features are extracted. The processing time for extracting features often requires more than the capturing interval, so the processing time tends to increase as the number of images increases. In order to reduce the number of images processed, there is a need for high-precision arrival prediction.

The information processing apparatus 6 according to the sixth embodiment takes images in accordance with the arrival of the walker P at the focal plane F of the camera IC, thereby enabling the acquisition of iris images suitable for iris recognition and improving the recognition performance of iris recognition. In addition, since the information processing apparatus 6 can acquire iris images suitable for iris recognition with a small number of images, the information processing apparatus 6 can perform iris recognition of the walker P in a short time.

### 7: Supplementary Note

The following supplementary note is disclosed regarding the embodiments described above.

### Supplementary Note 1

An information processing apparatus including:
an acquisition unit that acquires gait information indicating a gait of a target;
an arrival estimation unit that estimates when the target will arrive at a focal plane of a camera based on the gait information; and
a control unit that controls a capturing by the camera in accordance with the estimation result of the arrival estimation unit.

### Supplementary Note 2

The information processing apparatus according to Supplementary Note 1, wherein
the gait information includes a gait model that imitates periodic displacement of a specified part of the target in the gait of the target, and
the acquisition unit includes a gait model estimation unit that estimates the gait model based on displacement information that indicates the displacement of the specified part of the target in three-dimensional space and distance information that indicates the distance between the camera and the specified part of the target.

### Supplementary Note 3

The information processing apparatus according to Supplementary Note 2, wherein
the arrival estimation unit estimates a phase in a cycle of the gait model in case the target arrives at the focal plane of the camera based on the gait model, the displacement information, and the distance information to estimates when the target will arrive at the focal plane of the camera.

### Supplementary Note 4

The information processing apparatus according to Supplementary Note 3, wherein
speed distribution information indicating the correspondence between gait phase and change in moving speed is registered in advance, and
the arrival estimation unit estimates a phase in a cycle of the gait model in case the target arrives at the focal plane of the camera by using the speed distribution information to estimates when the target will arrive at the focal plane of the camera.

### Supplementary Note 5

The information processing apparatus according any one of Supplementary Notes 2 to 4, wherein
the acquisition unit includes a stride estimation unit that estimates a stride of the target based on the displacement information and the distance information, and
the arrival estimation unit further uses the stride of the target to estimate when the target will arrive at the focal plane of the camera.

### Supplementary Note 6

The information processing apparatus according any one of Supplementary Notes 1 to 4, wherein
the control unit controls the camera to capture an iris image including an iris of the target, and further comprises
an iris recognition unit that performs iris recognition by matching the iris image with a registered iris image that has been registered in advance.

### Supplementary Note 7

An information processing method including:
acquiring gait information indicating a gait of a target;
estimating when the target will arrive at a focal plane of a camera based on the gait information; and
controlling a capturing by the camera in accordance with the estimation result.

### Supplementary Note 8

A recording medium on which a computer program that allows a computer to execute an information processing method is recorded, the information processing method including:
acquiring gait information indicating a gait of a target;
estimating when the target will arrive at a focal plane of a camera based on the gait information; and
controlling a capturing by the camera in accordance with the estimation result.

This disclosure may be changed as appropriate within the scope that does not contradict the technical idea that can be read from the claims and the entire description. The information processing apparatus, information processing method, and recording medium with such changes are also included in the technical idea of this disclosure.

### DESCRIPTION OF REFERENCE CODES

1, 2, 3, 4, 5, 6 information processing apparatus
11, 211, 511 gait acquisition unit
2111 gait model estimation unit
12, 212, 312, 412, 512 arrival estimation unit
13, 213 control unit
214 information acquisition unit
3121 position estimation unit
3122 phase estimation unit
4123 speed estimation unit
421 speed distribution information storage unit
5112 stride length estimation unit
615 iris recognition unit
6151 focused image acquisition unit
6152 features extraction unit
622 registered iris information storage unit
6153 matching unit
IC camera
VC visible camera
S distance sensor

What is claimed is:

1. An information processing apparatus comprising:
at least one memory storing instructions; and
at least one processor that is configured to execute the instructions to:
acquire gait information indicating a gait of a target;
estimate when the target will arrive at a focal plane of a camera based on the gait information; and
control a timing of a capturing by the camera in accordance with the estimation result of the arrival estimation unit.

2. The information processing apparatus according to claim 1, wherein
the gait information includes a gait model that imitates periodic displacement of a specified part of the target in the gait of the target, and
the at least one processor that is configured to execute the instructions to estimate the gait model based on displacement information that indicates the displacement of the specified part of the target in three-dimensional space and distance information that indicates the distance between the camera and the specified part of the target.

3. The information processing apparatus according to claim 2, wherein
the at least one processor that is configured to execute the instructions to estimate a phase in a cycle of the gait model in case the target arrives at the focal plane of the camera based on the gait model, the displacement information, and the distance information to estimates when the target will arrive at the focal plane of the camera.

4. The information processing apparatus according to claim 3, wherein
speed distribution information indicating the correspondence between gait phase and change in moving speed is registered in advance, and
the at least one processor that is configured to execute the instructions to estimate a phase in a cycle of the gait model in case the target arrives at the focal plane of the camera by using the speed distribution information to estimates when the target will arrive at the focal plane of the camera.

5. The information processing apparatus according any one of claim 2, wherein the at least one processor that is configured to execute the instructions to:
estimate a stride of the target based on the displacement information and the distance information; and
use the stride of the target to estimate when the target will arrive at the focal plane of the camera.

6. The information processing apparatus according any one of claim 1, wherein the at least one processor that is configured to execute the instructions to:
control the camera to capture an iris image including an iris of the target; and
perform iris recognition by matching the iris image with a registered iris image that has been registered in advance.

7. An information processing method comprising:
acquiring gait information indicating a gait of a target;
estimating when the target will arrive at a focal plane of a camera based on the gait information; and
controlling a timing of a capturing by the camera in accordance with the estimation result.

8. A non-transitory recording medium on which a computer program that allows a computer to execute an information processing method is recorded, the information processing method including:
acquiring gait information indicating a gait of a target;
estimating when the target will arrive at a focal plane of a camera based on the gait information; and
controlling a timing of a capturing by the camera in accordance with the estimation result.
